(19) United States
(12) Patent Application Publication
(10) Pub. No.: US 2013/0218903 A1
(43) Pub. Date: Aug. 22, 2013

(54) PROGRAM ANALYSIS APPARATUS, PROGRAM ANALYSIS METHOD AND STORAGE MEDIUM

(71) Applicants: Kenji Funaoka, Kanagawa (JP); Nobuaki Tojo, Tokyo (JP); Susumu Takeda, Kanagawa (JP); Akira Kuroda, Kanagawa (JP); Hidenori Matsuzaki, Tokyo (JP)

(72) Inventors: Kenji Funaoka, Kanagawa (JP); Nobuaki Tojo, Tokyo (JP); Susumu Takeda, Kanagawa (JP); Akira Kuroda, Kanagawa (JP); Hidenori Matsuzaki, Tokyo (JP)

(73) Assignee: KABUSHIKI KAISHA TOSHIBA, Tokyo (JP)

(21) Appl. No.: 13/423,576

(22) Filed: Mar. 19, 2012

(30) Foreign Application Priority Data
Feb. 21, 2012 (JP) 2012-035368

(51) Int. Cl. G06F 17/30

(52) U.S. Cl. 707/748; 707/756; 707/E17.033

(57) ABSTRACT

It is to provide: a generation unit configured to generate one or more reference relationship pairs with reference certainty information of “uncertainty” as presentation information based on first reference relationship information showing whether it is “certain” for the reference data to refer the referenced data or it is “uncertain” for the reference data to refer the referenced data, every reference relationship pair formed with reference data and referenced data; and a conversion unit configured to convert the first reference relationship information into second reference relationship information using an input of a reference relationship for presentation information and reference dependence relationship information showing a dependence relationship between reference relationship pairs.

### CROSS-REFERENCE TO RELATED APPLICATIONS

This application is based upon and claims the benefit of priority from Japanese Patent Application No. 2012-035368, filed on Feb. 21, 2012; the entire contents of which are incorporated herein by reference.

### FIELD

Embodiments of the present invention relate to a program analysis apparatus, a program analysis method and a storage medium.

### BACKGROUND

In the related art, there is a technique of enhancing program performance by parallelizing loops when a user instructs that there is no dependence between loop iterations in a case where it is not clear whether there is dependence between loop iterations. In this technique, in a case where it is not clear whether there is dependence between loop iterations, although parallelization cannot be automatically performed to ensure correct operations, parallelization is possible by user's instruction that there is no dependence.

However, if the above technique is applied to pointer analysis, targets to be instructed potentially exist by the number of combinations of a pointer and actual data or the number of combinations of pointers, and therefore there arises a problem that the energy or time required for user's instruction increases.

### BRIEF DESCRIPTION OF THE DRAWINGS

FIG. 1 is a block diagram illustrating a configuration example of a program optimization apparatus according to a first embodiment;

FIG. 2 is a diagram illustrating a configuration example of a computer system mounting a program optimization apparatus;

FIG. 3 is a flowchart illustrating an example of the overall operation of a program optimization apparatus;

FIG. 4 is a diagram illustrating an example of a first program;

FIG. 5 is a diagram illustrating an execution example of function “transfer_image all”, function “transfer_image”, task “prepare” and task “get”;

FIG. 6 is a diagram illustrating an example of first reference relationship information;

FIGS. 7A and 7B are diagrams illustrating examples of reference dependence relationship information showing reference dependence relationships of reference relationship pairs;

FIG. 8 is a diagram illustrating an example of trace information;

FIG. 9 is a diagram illustrating an example of access count information;

FIG. 10 is a diagram illustrating an example of group access information;

FIG. 11 is a diagram illustrating an example of program information;

FIG. 12 is a diagram illustrating an example of intermediate reference relationship information;

FIG. 13 is a diagram illustrating an example of the ranking by function attributes;

FIG. 14 is a diagram illustrating an example of group access information updated using intermediate reference relationship information;

FIG. 15 is a diagram illustrating an example of task group attribute information;

FIG. 16 is a diagram illustrating an example of the ranking by task group attribute information;

FIG. 17 is a diagram illustrating an example of a result of performing ranking by the access count;

FIG. 18 is a diagram illustrating an example of presentation information showing a reference relationship pair to which the highest rank is finally given;

FIG. 19 is a diagram illustrating an example showing a plurality of reference relationship pairs as presentation information;

FIG. 20 is a diagram illustrating an example of reference instruction information;

FIG. 21 is a diagram illustrating an example of second reference relationship information;

FIG. 22 is a diagram illustrating an example of group access information updated using second reference relationship information;

FIG. 23 is a diagram illustrating an example of task group attribute information based on group access information updated using second reference relationship information;

FIG. 24 is a diagram illustrating an example of a second program;

FIG. 25 is a diagram illustrating an example of expressing an indirect relationship between reference data and referenced data by a reference relationship pair;

FIG. 26 is a diagram illustrating another example of the first program;

FIG. 27 is a diagram illustrating an example of first reference relationship information according to a second embodiment;

FIG. 28 is a diagram illustrating an example of presentation information related to a reference equivalence relationship pair;

FIG. 29 is a diagram illustrating an example of a second program output as an executable file;

FIG. 30 is a diagram illustrating an example of a computer system of a high optimization effect according to a third embodiment;

FIG. 31 is a diagram illustrating a configuration example of a computer system having a plurality of processor cores;

FIG. 32 is a diagram illustrating an example of classifying tasks into task groups for each referenced data to be accessed; and

FIG. 33 is a diagram illustrating an example of reconfigured task groups.

### DETAILED DESCRIPTION

In general, according to one embodiment, it provides a program analysis apparatus that analyzes a reference relationship between reference data and referenced data that can be referred by the reference data in an analysis target program. This program analysis apparatus includes a generation unit configured to: select one or more reference relationship pairs with reference certainty information of “uncertainty” based on first reference relationship information including the reference certainty information showing whether it is “certain” for the reference data to refer the referenced data of the reference relationship pair or it is “uncertain” for the reference data to refer the referenced data of the reference relationship pair, every reference relationship pair including the reference data and the referenced data that can be referred by the reference data; and generate the selected reference relationship pairs as presentation information. Also, this program analysis apparatus includes an instruction unit configured to generate a reference relationship of the reference relationship pair, as reference instruction information. Further, this program analysis apparatus includes a conversion unit configured to convert first reference relationship information into second reference relationship information using reference instruction information and information of the dependence relationship between reference relationship pairs. The reference dependence relationship information denotes, in a case where a reference relationship of the second reference relationship pair can be estimated based on a reference relationship of the first reference relationship pair, information showing correspondence between a presumption of the reference relationship of the first reference relationship pair and the reference relationship of the second reference relationship pair estimated by performing the presumption.

A program analysis apparatus, a program analysis method and a storage medium according to embodiments will be explained below in detail with reference to the drawings. The present invention is not limited to the following embodiments.

### First Embodiment

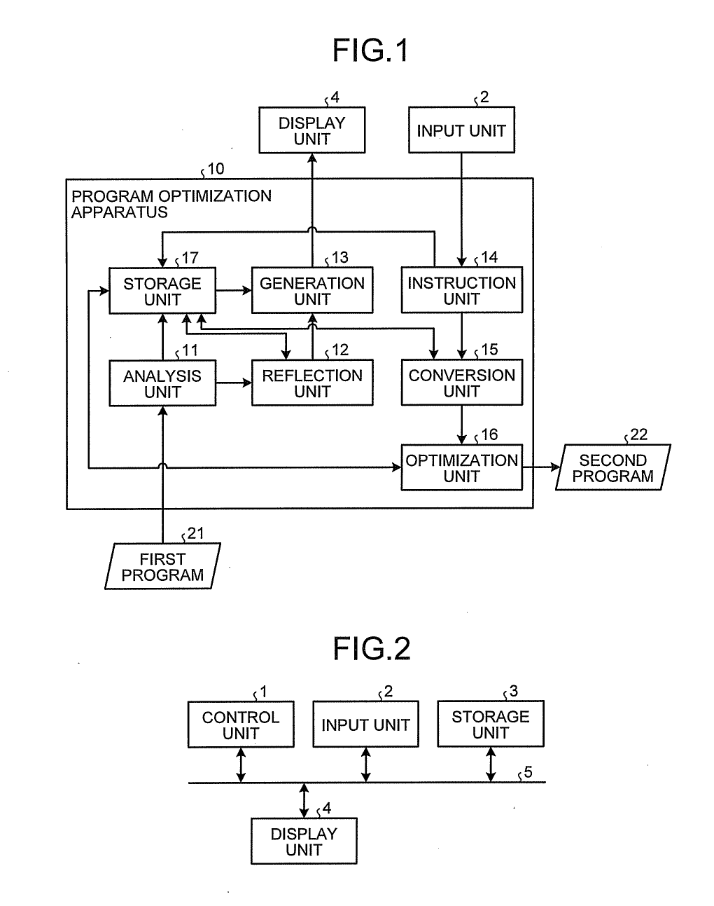

FIG. 1 is a block diagram illustrating a configuration example of a program optimization apparatus 10 according to the first embodiment. The program optimization apparatus 10 optimizes a first program (analysis target program) 21 and outputs a second program 22 as an optimization result. The program optimization apparatus 10 has an analysis unit 11, a reflection unit 12, a generation unit 13, an instruction unit 14, a conversion unit 15, an optimization unit 16 and a storage unit 17. Here, the program optimization apparatus 10 having the optimization unit 16 to optimize a program will be explained as an example in the present embodiment, but a program analysis apparatus that has the configuration of FIG. 1 excluding the optimization unit 16 and analyzes a reference relationship of data in the first program, may be configured.

The program optimization apparatus 10 is mounted on a computer such as a personal computer and a server. FIG. 2 is a diagram illustrating a configuration example of a computer system mounting the program optimization apparatus 10. The computer system shown in FIG. 2 has a control unit 1, an input unit 2, a storage unit 3 and a display unit 4, which are connected through a bus 5.

The control unit 1 is configured with, for example, a CPU (Central Processing Unit) and an MPU (Micro Processing unit), and executes various programs. The input unit 2 has, for example, a keyboard and a mouse, and accepts an input from a user. The storage unit 3 includes various memories such as RAM (Random Access Memory) and ROM (Read Only Memory) and a storage device such as a hard disk, and stores, for example, a program to be executed in the control unit 1 and essential data obtained in the processing process. The display unit 4 is configured with, for example, a liquid crystal display or a plasma display, and displays various screens for the user of the computer system. The configuration of FIG. 2 is just an example and a computer mounting the program optimization apparatus 10 may have any configuration.

An operation example of the program optimization apparatus 10 of the present embodiment will be explained. In the computer system of FIG. 2, for example, an analysis program to execute an operation (i.e. operations including program analysis processing) of the program optimization apparatus 10 is installed from a storage medium such as a CD-ROM. The control unit 1 executes program analysis processing according to an analysis program stored in the storage unit 3.

In the above example, although an optimization program is provided using a CD-ROM as a storage medium, the present embodiment is not limited to this, and it may be possible to use a program provided by a storage medium such as a magnetic disk and a transmission medium such as the Internet, according to the configuration of the computer system or the capacity of the provided program.

The storage unit 3 includes the storage unit 17 of FIG. 1. The analysis unit 11, the reflection unit 12, the generation unit 13, the instruction unit 14, the conversion unit 15 and the optimization unit 16 are included in the control unit 1.

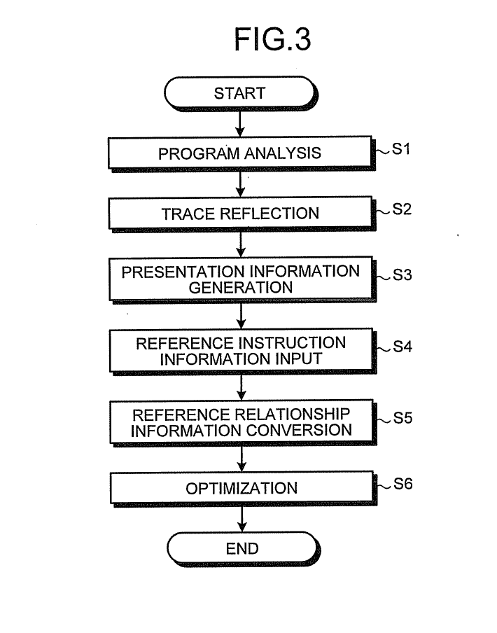

Next, operations of the program optimization apparatus 10 will be explained. FIG. 3 is a flowchart showing an example of the overall operation of the program optimization apparatus 10. The analysis unit 11 analyzes an input first program 21 (step S1). To be more specific, the analysis unit 11 generates first reference relationship information, reference dependence relationship information, trace information, access count information, group access information and program information, stores them in the storage unit 17 and reports to the reflection unit 12 that the storage was performed. The reflection unit 12 reads the first reference relationship information, the trace information and the reference dependence relationship information from the storage unit 17 and converts the first relationship information into intermediate reference relationship information using information of the trace information and the reference dependence relationship information (step S2). Further, the reflection unit 12 stores the intermediate reference relationship information in the storage unit 17 reports to the generation unit 13 that the conversion was performed.

Next, the generation unit 13 reads the intermediate reference relationship information, the access count information and the group access information from the storage unit 17 and generates presentation information from the intermediate reference relationship information based on the access count information and the group access information (step S3). The presentation information is displayed in the display unit 4.

The instruction unit 14 accepts an input of reference instruction information from the user via the input unit 2 and stores the input reference instruction information in the storage unit 17 (step S4). The instruction unit 14 reports to the conversion unit 15 that the reference instruction information was stored.

Next, the conversion unit 15 reads the intermediate reference relationship information, the reference instruction information and the reference dependence relationship information from the storage unit 17 and converts the intermediate reference relationship information into second reference relationship information using the reference instruction information and the reference dependence relationship information (step S5). Further, the conversion unit 15 stores the second reference relationship information in the storage unit 17 and reports to the optimization unit 16 that the conversion was performed.

Next, the optimization unit 16 reads the second reference relationship information and the program information from the storage unit 17 and constructs the second program 22 optimized using the second reference relationship information and the program information (step S6).

In the above example, although each functional unit reports to the functional unit of performing the next processing that each processing was performed, instead of this, it may be possible to provide a section for overall control in the control unit 1 so that the section controls the execution timing of the processing of each functional unit.

In the following explanation, an example case will be explained where the functional units of the program optimization apparatus 10 serially operate in the most basic form in the order described in FIG. 3. However, the present embodiment is not limited to this. For example, it may be possible to perform an operation by a configuration of performing operations in cooperation with a plurality of functional units, a configuration of rearranging the order of partial functional units, a configuration of dividing a given functional unit into a plurality of functional blocks, or a configuration of combining these three forms. Also, for example, in a case where only the reference instruction information is changed, an operation may be possible in or after step S4 in FIG. 3 so that an operation of a partial functional unit of the functional units in FIG. 1 is possible. Also, it is possible to divide a functional unit into a plurality of modules and perform an operation.

Next, the processing of each functional unit and the term or information used for processing will be explained.

### (Analysis Unit 11)

The analysis unit 11 analyzes the input first program 21 and extracts the first reference relationship information, the reference dependence relationship information, the trace information, the access count information, the group access information and the program information.

### (First Program)

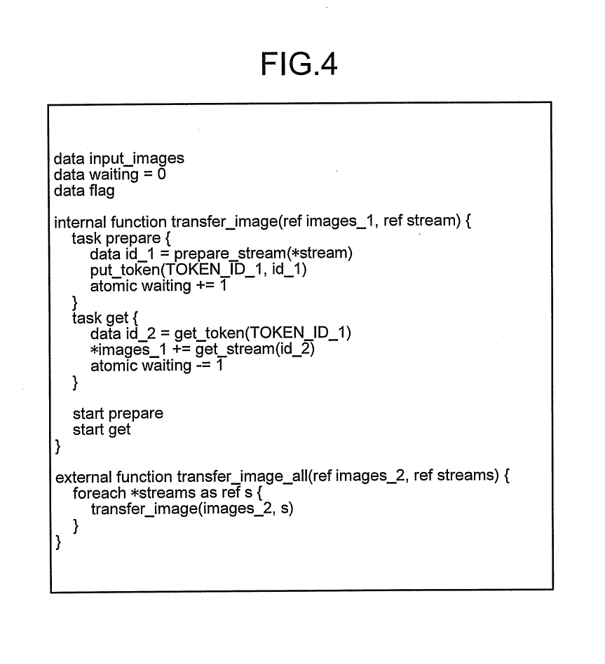

FIG. 4 is a diagram showing an example of the first program 21. The first program 21 shown in FIG. 4 is described in pseudo-program language similar to the C language. The first program 21 is not limited to the example in FIG. 4 but may be described in any language.

### (Reference Data and Referenced Data)

Data included in the first program 21 is classified broadly into the reference data and the referenced data. The reference data denotes special data to access other data, links to data of the access target and can change the link destination. Its examples include the pointer variable of the C language. In FIG. 4, the reference data is defined using “ref” as a keyword. In FIG. 4, as the reference data, there are “images_1”, “images_2”, “stream”, “streams” and “s”.

The referenced data denotes data to be accessed via the reference data. In FIG. 4, the referenced data is defined using “data” as a keyword. In FIG. 4, as the referenced data, there are “input_images”, “waiting”, “flag”, “id_1” and “id_2”.

### (Direct Data Access and Indirect Data Access)

Methods of accessing data are broadly classified into the direct data access and the indirect data access. The direct data access denotes a method of directly accessing referenced data not via reference data. FIG. 4 shows direct data access using the name of referenced data. For example, waiting+=1 is provided. In the direct data access, data of the access destination is described by the name, so that it is possible to analyze data to be actually accessed.

The indirect data access denotes a method of accessing referenced data via reference data. In FIG. 4, a “*” operator is used to access referenced data via reference data. For example, “*images_1” is provided. The indirect data access determines referenced data to be accessed at the time of execution according to content of reference data, and therefore there is a case where it is not possible to analyze the referenced data to be actually accessed.

### (Function)

FIG. 4 defines two functions of “transfer_image” and “transfer_image_all” by a keyword of “function”. In a bracket after the function name, the functional parameter is described. The parameters of the function “transfer_image” in FIG. 4 are reference data “images_1” and reference data “stream”. The data designated as a parameter takes over data designated by a function call. For example, in a case where a function call of “transfer_image (images_2, s)” is made, the data “images_1” takes over the value of the data “images_2” and the data “stream” takes over the value of the data “s”.

### (Functional Access Attribute)

It is possible to set an access attribute of “internal” or “external” to a function. In FIG. 4, while the “internal” does not allow a call from the outside of a program, the “external” allows a call from the outside of the program. Function “transfer_image_all” in FIG. 4 is set as the “external” and therefore can be called from the outside of the first program 21.

### (Task)

In FIG. 4, two tasks of “prepare” and “get” are defined by a task keyword. For example, “task prepare” is provided. A task is performed by a start keyword.

### (Difference Between Function and Task)

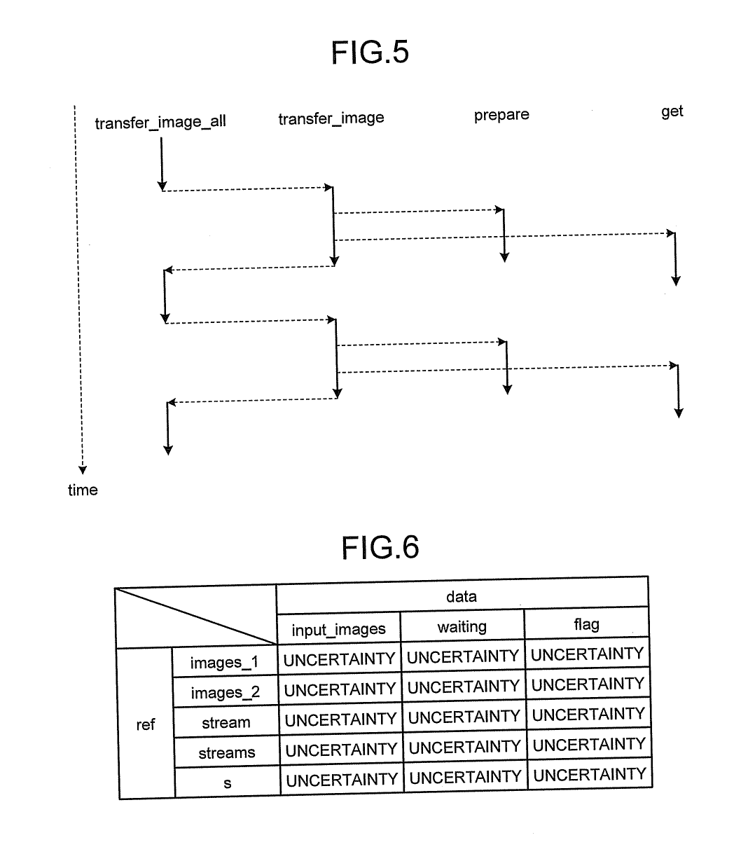

While a function temporarily stops the currently-executed processing and executes functional processing, a task executes task processing in parallel with the currently-executed processing. FIG. 5 is a diagram illustrating an execution example of the function “transfer_image all”, the function “transfer_image”, the task “prepare” and the task “get” in the first program 21 of FIG. 4. If the function “transfer_image” is called during execution of the function “transfer_image_all”, the function “transfer_image_all” is temporarily stopped and the function “transfer_image” is executed. After that, when processing of the function “transfer_image” is finished, processing of the function “transfer_image_all” restarts. On the other hand, if the task “prepare” is called during execution of the function “transfer_image”, processing of the function “transfer_image” is not stopped and processing of the task is executed in parallel. The above-described difference between the function and the task indicates a difference of potential processing expressed by description, and what kind of processing is actually performed is determined by a program execution environment such as a compiler and an OS (Operating System).

### (Loop)

FIG. 4 describes loop processing expressed by “foreach” in the function “transfer_image_all”. In this loop processing, array data to be referred by the reference data “streams” is accessed by “streams” and individual elements of the array data are referred by the reference data “s” while the function “transfer_image” in the loop processing is executed.

### (Reference Relationship Information and Reference Relationship Pair)

The analysis unit 11 analyzes the first program 21 and generates first reference relationship information. This analysis denotes a static analysis based on content described in the definition sentence and execution sentence of the first program 21. FIG. 6 is a diagram illustrating an example of reference relationship information obtained by analyzing the first program 21 shown in FIG. 4. The first reference relationship information shows information as to whether given referenced data is referred by given reference data. FIG. 6 is a table illustrating reference relationships between reference data and referenced data.

### (Certain Reference Relationship, Uncertain Reference Relationship and Non-Referenced Relationship)

Reference relationship information includes three kinds of information: “certain” reference relationship, “uncertain” reference relationship and “non-referenced relationship”. Information indicating whether each reference relationship is certain or uncertain is referred to as “reference certainty information”. For example, FIG. 6 shows that reference certainty information for the reference data “images_1” and the referenced data “input_images” shows uncertainty. A non-referenced relationship is not used for the program optimization processing of the present embodiment and is therefore not included in the first reference relationship information shown in FIG. 6.

“Certain” reference relationship includes cases where reference data always refers referenced data and reference data sometimes refer referenced data. Therefore, even when reference certainty information shows certainty, reference data may not refer referenced data. An uncertain reference relationship means that it is not possible to decide whether reference data can or cannot refer referenced data. A non-referenced relationship is regarded that reference data never refer referenced data.

In the first program 21 in FIG. 4, the referenced data “input_images”, “waiting” and “flag” can be designated as a parameter of the “external” function “transfer_image_all”. However, it is not possible to decide whether these referenced data is actually designated as a parameter unless processing of calling the function “transfer_image_all” is all identified and can be all analyzed. Therefore, at the timing of the first reference relationship information in FIG. 6, the reference certainty information shows uncertainty.

Similar to a case of the C language, Local data “id_1” and “id_2” of the tasks “prepare” and “get” in FIG. 4 cannot be used outside the function. Therefore, it is possible to analyze that the referenced data “id_1” and “id_2” have a non-reference relationship in which they cannot be referred by the reference data included in the first program 21 in FIG. 4. As a precondition, it is known that a second parameter of a function “put_token” is passed by value, in other words, reference data that refers the referenced data “id_1” cannot be used in, for example, the function “get_token”. In view of the above, the referenced data “id_1” and “id_2” cannot be referred by reference data and therefore are not included in the first reference relationship information in FIG. 6.

### (Reference Dependence Relationship Information)

The analysis unit 11 analyzes the first program and extracts reference dependence relationship information.

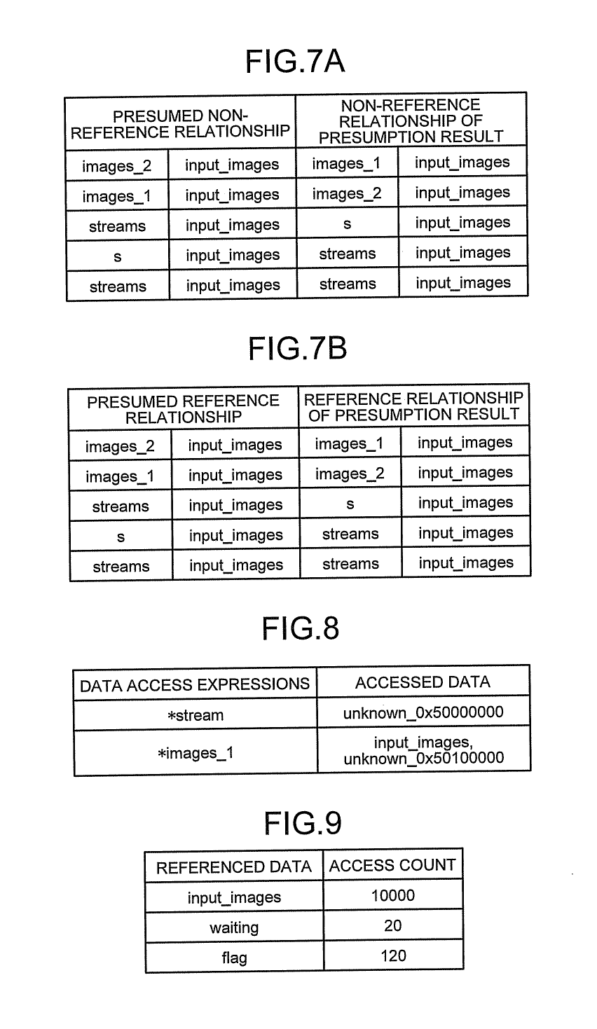

FIG. 7 is a diagram illustrating an example of the reference dependence relationship information obtained by analyzing the first program 21 shown in FIG. 4. The reference dependence relationship indicates a relationship in which one reference relationship is presumed if the other reference relationship can be presumed. Its examples include a relationship in which a reference relationship B can be regarded as present if a reference relationship A is regarded as certainty, a relationship in which a reference relationship D can be regarded as a non-reference relationship if a reference relationship C is regarded as a non-reference relationship, and a relationship in which a reference relationship F can be regarded as a non-reference relationship if a reference relationship E is regarded as certainty.

FIG. 7A shows reference relationship pairs that can be presumed as a non-reference relationship as a result of presumption in a case where given reference relationship pairs are presumed as a non-reference relationship. In FIG. 7A, the left side shows reference relationship pairs presumed as a non-reference relationship, and the right side shows reference relationship pairs that can be regarded as a non-reference relationship according to presumption of the left-side reference relationship pair on the same stage.

FIG. 7B shows reference relationship pairs that can be presumed as a reference relationship as a result of presumption in a case where given reference relationship pairs are presumed as a reference relationship. In FIG. 7B, the left side shows reference relationship pairs presumed as a reference relationship, and the right side shows reference relationship pairs that can be regarded as a reference relationship according to presumption of the left-side reference relationship pair on the same stage.

For example, the first stage in FIG. 7A shows that, if a reference relationship pair of “images_2” and “input_images” can be regarded as a non-reference relationship, a reference relationship pair of “image_1” and “input_images” can be regarded as a non-reference relationship too. This is because, since the function “transfer_image” is designated as “internal”, a function call from the function “transfer_image_all” is only one function call and the reference data “images_1” and the reference data “images_2” are substantially equivalent. Therefore, it is possible to obtain information that, if the reference data “images_2” does not refer the referenced data “input_images”, the reference data “images_1” does not refer the referenced data “input_images” either.

Also, by analyzing a data flow of reference data, it is possible to analyze a reference dependence relationship. For example, the array elements of referenced data to be referenced by the reference data “streams” are referred by the reference data “s”, and the reference data “s” is equivalent to the reference data “stream”. Therefore, taking into account a data flow from the reference data “streams” to the reference data “stream” via the reference data “s”, it is possible to analyze that, if the reference data “streams” does not refer the referenced data “input_images”, the reference data “s” does not refer the referenced data “input_images” either. Similarly, it is possible to analyze other reference dependence relationships.

The reference dependence relationship information is not limited to the forms in FIG. 7 but can be in other forms as long as it is information associating reference relationships of first reference relationship pairs with reference relationships of second reference relationship pairs estimated in this case. The reference dependence information does not need to include all reference dependence relationships.

### (Trace Information)

The analysis unit 11 executes the first program 21 and generates trace information recording currently-executed data access. FIG. 8 is a diagram illustrating an example of trace information obtained by executing the first program 21 in FIG. 4. The trace information includes information that can identify referenced data indirectly accessed using reference data. FIG. 8 shows data access expressions to indirectly access data and data accessed by the data access expressions. The trace information needs not record all data accesses.

In FIG. 8, accessed data “unknown_{—}0x50000000” shows that referenced data, which is provided in an address “0x50000000” and cannot be identified, is accessed. That is, it is considered that referenced data outside the first program 21 is accessed. FIG. 8 shows that the data access expression “*images_1” accesses that referenced data “input_images” and the unidentified referenced data “unknown_{—}0x50100000”.

The trace information is obtained by executing the program and therefore there is a possibility of obtaining information that cannot be obtained only by statically analyzing the first program 21 in FIG. 4.

### (Data Access Count Information)

The analysis unit 11 executes the first program 21 and generates access count information recording a currently-executed data access count. This execution may be performed simultaneously with or separately from that of trace information.

FIG. 9 is a diagram illustrating an example of access count information per referenced data obtained by executing the first program 21 in FIG. 4. The data access count denotes the direct data access count for each data, the indirect data access count for each data or a sum of these, and it is possible to use any of these. In FIG. 9, it shows a sum of direct data access and indirect data access. FIG. 9 shows that, for example, there are 10000 data accesses to “input_images”. The access count information needs not record all data accesses.

### (Task Group and Group Access Information)

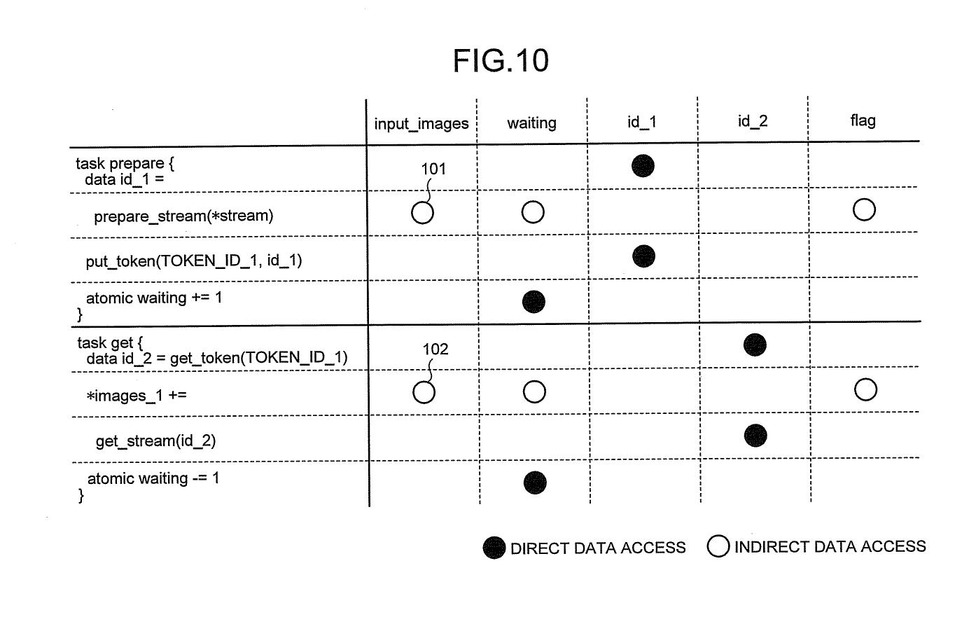

The analysis unit 11 analyzes the first program 21 and generates group access information showing affiliation relationships of direct data access and indirect data access in task groups. FIG. 10 is a diagram illustrating an example of group access information obtained from the first program 21 in FIG. 4.

A task group includes one or more tasks. Here, two task groups of a task group formed with the task “prepare” and a task group formed with the task “get” are defined. In FIG. 10, the direct data access to each referenced data is expressed by a black circle, the indirect data access to each referenced data is expressed by a white circle, and no access to each referenced data is expressed by a blank. For example, data access to “input_images” is indirect data access of “stream” 101 in the task “prepare” and “images_1” 102 in the task “get”.

By group access information, it is possible to identify to which task group the direct data access and indirect data access to each data belong. In FIG. 10, as an example of the form of group access information the task codes in the first program as task groups are described together. However the actual form of group access information is not limited to this. Any group access information is possible as long as it shows access (direct data access, indirect data access or no access) in each task group every referenced data.

### (Program Information)

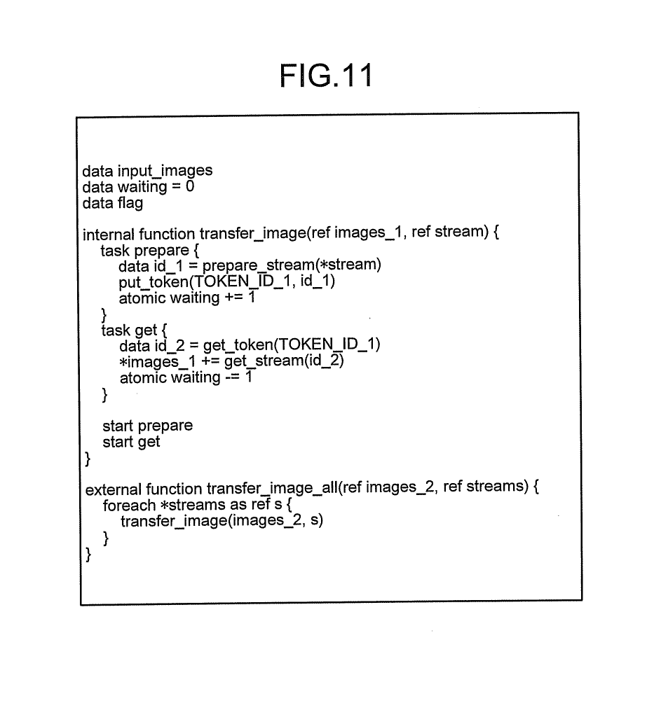

FIG. 11 is a diagram illustrating an example of program information of the first program 21 in FIG. 4. The program information is used in the optimization unit 16 to optimize the first program and construct a second program. The program information denotes information showing actual content of the first program. In the present embodiment, although the first program 21 itself in FIG. 4 is used as program information, for example, a result of machine language conversion may be used as program information. Examples of program information include information showing a construction of the first program 21, information showing an internal data construction obtained by converting a construction of the first program into a different construction, information related to functions and information related to data. What kind of information has to be held as program information depends on what kind of second program is output, and therefore various kinds of information can be program information.

### (Reflection Unit 12)

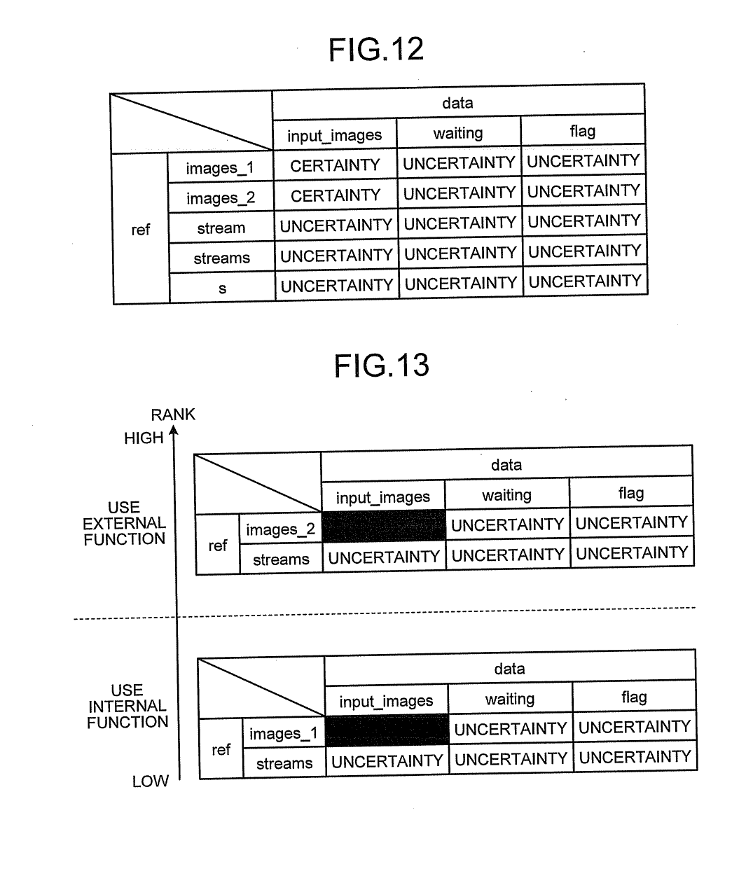

The reflection unit 12 converts first reference relationship information into intermediate reference relationship information using trace information and reference dependence relationship information. FIG. 12 is a diagram illustrating an example of converting the first reference relationship information in FIG. 6 into intermediate reference relationship information using the reference dependence relationship information in FIG. 7 and the trace information in FIG. 8.

The trace information in FIG. 8 shows that the referenced data “input_images” is accessed using the reference data “images_1”. Therefore, the reflection unit 12 changes reference certainty information for the reference data “images_1” and the referenced data “input_images” from uncertainty to certainty. Using the reference dependence relationship information in FIG. 7, the reflection unit 12 changes reference certainty information for the reference data “images_2” and the referenced data “input_images” from uncertainty to certainty.

Thus, by reflecting the trace information and the reference dependence relationship information to the first reference relationship information, the reflection unit 12 converts the first reference relationship information into the intermediate reference relationship information. Therefore, in the intermediate reference relationship information, compared to the first reference relationship information, there are less uncertain reference relationship pairs for which the user of the program optimization apparatus 10 needs to decide an existence or inexistence of reference relationships. That is, an instruction cost which the user has to incur is reduced. The reflection unit 12 may convert the first reference relationship information into the intermediate reference relationship information using only the trace information, without using the reference dependence relationship information.

### (Generation Unit 13)

The generation unit 13 generates rank information using, for example, access count information and group access information, and generates presentation information from intermediate reference relationship information based on the rank information. The generation unit 13 instructs the display unit 4 to display the generated presentation information and the display unit 4 displays the presentation information.

### (Rank Information)

Rank information denotes information used to give a priority level to a reference relationship pair. It is preferable to give a higher rank to a reference relationship pair of higher performance in a case where it is presumed that there is no reference relationship. Therefore, the rank information is given to a reference relationship pair in which at least reference certainty information indicates “uncertainty”. In the following, an explanation will be given to examples using the access attribute of a function to which a reference relationship pair belongs, group access information or the access count of referenced data, as an index of deciding a reference relationship pair of higher performance in a case where it is presumed that there is no reference relationship. In the present embodiment, by performing ranking in a stepwise fashion under a plurality of conditions, presentation information related to a reference relationship pair of the highest rank is generated.

For example, it is possible to perform stepwise ranking based on the access count to the referenced data of each reference relationship pair. It may be possible to give the same rank to a plurality of reference relationship pairs. By this means, it is possible to efficiently provide presentation information to encourage the user to input a reference relationship.

### (Ranking by Functional Access Attributes)

The generation unit 13 performs ranking by functional attributes so that the optimization unit 16 can perform optimization related to task data arrangement. To be more specific, regarding reference relationship pairs in which reference certainty information indicates “uncertainty”, a high rank is given to a reference relationship pair including reference data used in an “external” function.

FIG. 13 is a diagram illustrating an example of ranking by functional attributes. The generation unit 13 performs classification every function to which each reference relationship pair of intermediate reference relationship information belongs. The upper portion of FIG. 13 shows reference relationship information belonging to the “external” function. The lower portion of FIG. 13 shows reference relationship information belonging to the “internal” function. As shown in FIG. 13, the priority level of the “external” function is set higher than that of the “internal” function. A reference relationship pair in which the reference relationship is certain is expressed by black filling. The generation unit 13 stores this ranking information in the storage unit 17 as first rank information.

This is because, by tracing a reference data flow from an “external” function that can be called from the outside, it is expected to reduce analysis time by the user. If it is traced from the “internal” function, it is necessary to track the reference data flow via the “external” function.

### (Ranking by Group Access Information)

The generation unit 13 updates group access information using intermediate relationship information. Based on the updated group access information, the generation unit 13 gives priority levels to reference relationship pairs according to direct data access and indirect data access.

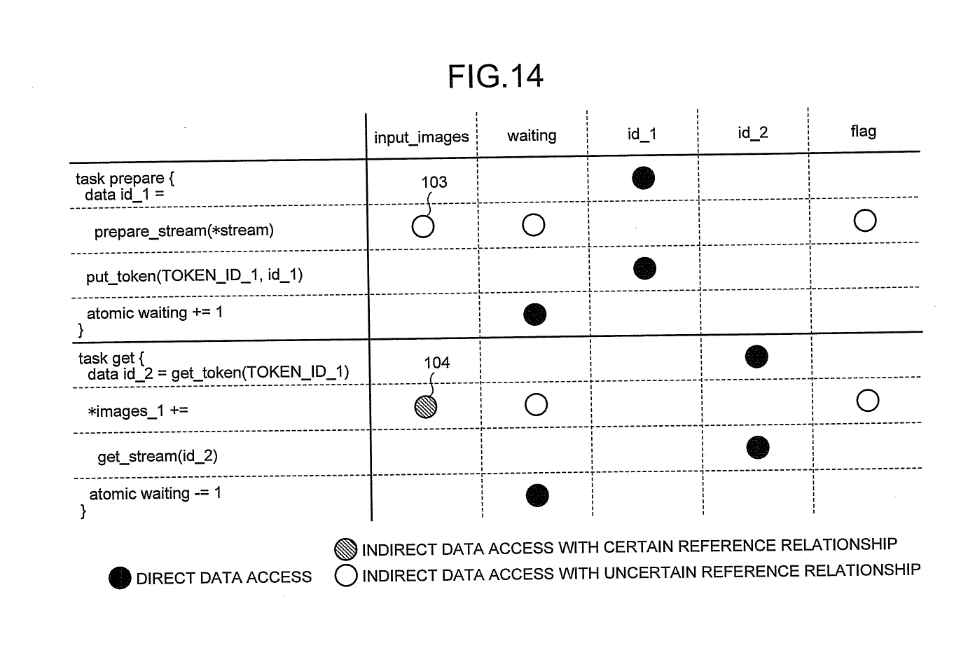

FIG. 14 is a diagram illustrating an example of updating the group access information in FIG. 10 using the intermediate reference relationship information in FIG. 12. In FIG. 14, the indirect data access is classified into the certain reference relationship and the uncertain reference relationship. In the intermediate reference relationship information in FIG. 12, the reference certainty information for the reference data “images_1” and the referenced data “input_images” is “certain”. Therefore, a field corresponding to this reference relationship pair is set to indirect data access 104 with the certain reference relationship. Meanwhile, the reference data “stream” and the referenced data “input_images” correspond to a reference relationship pair in which a reference certainty information is uncertain, and are therefore set to indirect data access 103 with the uncertain reference relationship.

The generation unit 13 uses group access information and generates attribute information of three classified task groups of the certain task group, the uncertain task group and the non-access task group for every referenced data. The certain task group denotes a task group including direct data access to the referenced data or indirect data access by reference data of a reference relationship pair with the reference certainty information of “certainty”. The uncertain task group is not a certain group and denotes a task group including indirect data access by reference data of a reference relationship pair in which the reference certainty information for the referenced data is “uncertain”. The non-access task group denotes a task group in which the referenced data is not accessed or is regarded not to be accessed.

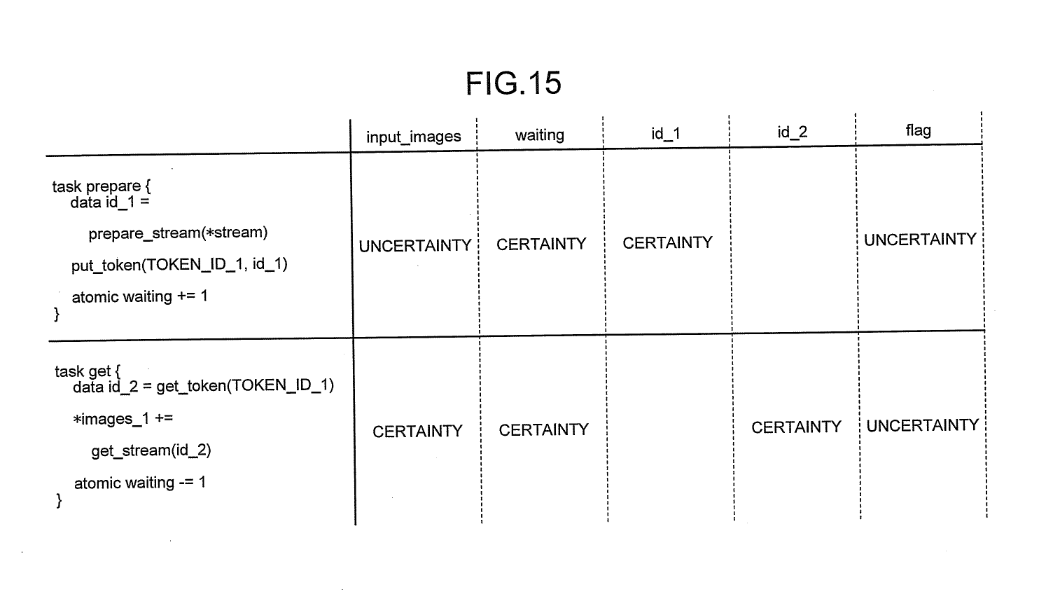

FIG. 15 is a diagram illustrating an example of task group attribute information related to each referenced data obtained from the group access information in FIG. 14. For example, the attribute of the task group including the task “prepare” with respect to the referenced data “input_images” is the uncertain task group because it includes only indirect data access using a reference relationship pair in which the reference certainty information is uncertain. The attribute of the task group including the task “get” with respect to the referenced data “input_images” is the certain task group because it includes indirect data access using a reference relationship pair in which the reference certainty information is certain. The attribute of the task group including the task “prepare” with respect to the referenced data “waiting” is the certain task group because it includes direct data access. The task group attributes of other task groups are determined in the same way. The blanks in FIG. 15 indicate the non-access task groups.

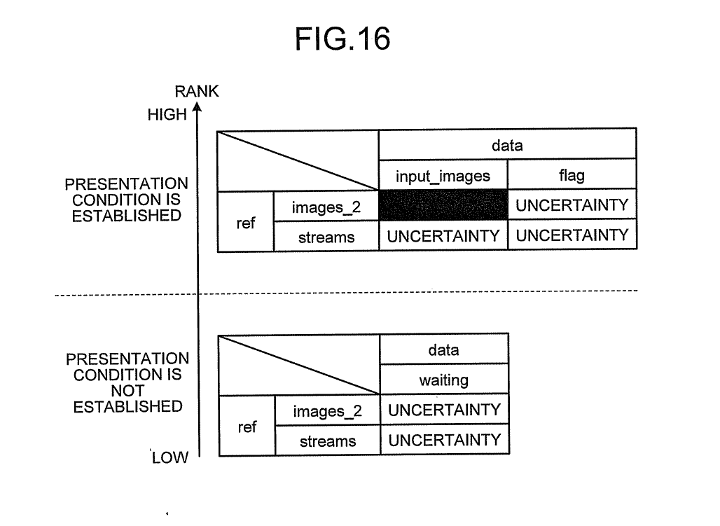

FIG. 16 is a diagram illustrating a result of further giving priority levels to the reference relationship pairs belonging to the “external” function of the high rank in FIG. 13. To be more specific, the generation unit 13 gives a higher rank to a reference relationship pair including referenced data in which a sum of the certain task group count and the uncertain task group count is equal to or greater than 2 and the certain task group count is equal to or less than 1, updates the rank information and stores it in the storage unit 17. For example, regarding the referenced data “input images” shown in FIG. 15, a sum of the certain task group count and the uncertain task group count is 2 and the certain task group count is 1. Therefore, a higher rank is given to a reference relationship pair having “input_images” as referenced data. For example, in the referenced data “waiting” shown in FIG. 15, the certain task group count is 2 and therefore a lower rank is given.

### (Ranking by Access Count)

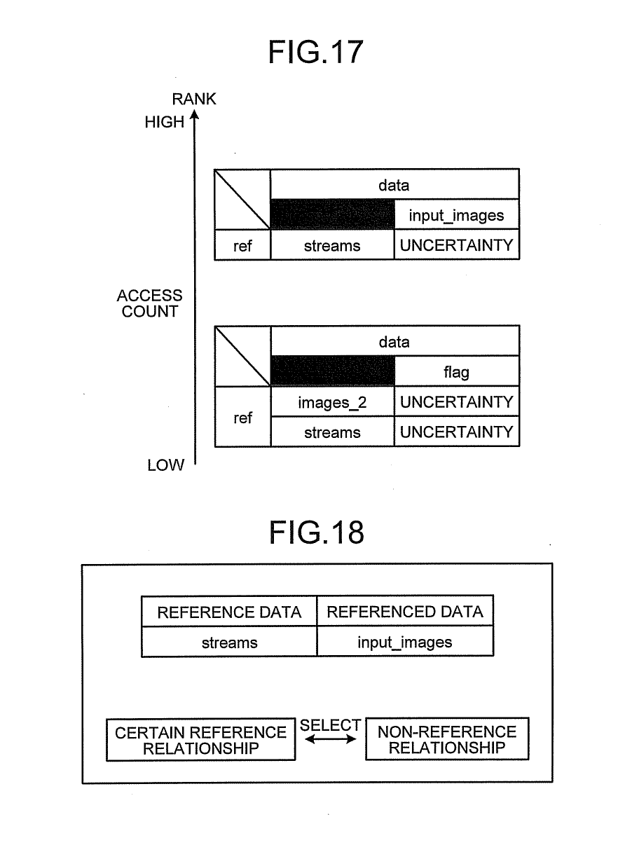

FIG. 17 is a view illustrating a result of further performing ranking by the access count for the reference relationship pairs in which the presentation conditions shown in FIG. 16 are established.

To be more specific, the generation unit 13 gives a higher rank to a reference relationship pair in which the access count of referenced data is larger. According to the access count information in FIG. 9, while “input_images” is accessed 10000 times, “flag” is accessed 120 times. Therefore, a higher rank is given to a reference relationship pair of the referenced data “input_images” and the rank information is updated and stored in the storage unit 17.

### (Presentation Information)

FIG. 18 is a diagram illustrating an example of presentation information showing a reference relationship pair to which the highest rank is eventually given. In the example of FIG. 18, as the presentation information screen-displayed in the display unit 4, a reference relationship of the reference data “streams” and the referenced data “input_images” to which the highest rank is given in FIG. 17, is shown. The upper portion shows the presentation information itself and the lower portion shows buttons to accept an input from the user. If the user selects the button of “certain reference relationship” or the button of “non-reference relationship” by, for example, a mouse, the input unit 2 reports input information based on the selected button to the instruction unit 14. Any screen display is possible as long as it can display equivalent information and accept an input from the user. Regarding a form of the presentation information, for example, the presentation information may be generated as data on the storage unit 3 such as a text file and a binary file so that the user can recognize it by, for example, the display unit 4 and printing.

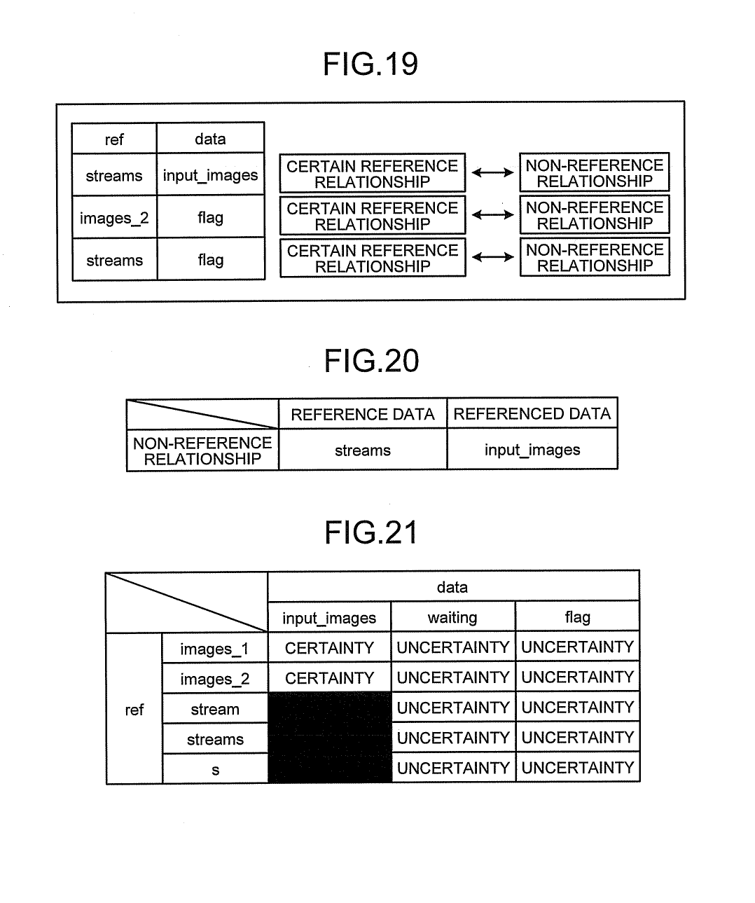

In FIG. 18, one reference relationship pair is displayed and selected as the presentation information, but it may be possible to display and select a plurality of reference relationship pairs. FIG. 19 illustrates an example of displaying presentation information in order of rank determined by task group attributes and access counts.

The generation unit 13 can change the order of ranking. The present embodiment has described ranking in order from functional attributes, task group attributes and data access counts. The ranking may be performed in any order, for example, in order from the task group attributes first and then the function attributes. The generation unit 13 may generate presentation information by performing ranking at least one time.

As a selection method of presentation information, for example, it may be possible to give a score to all reference relationship pairs in each stage and provide, as presentation information, a reference relationship pair showing a rank in which the score sum is eventually high.

In addition to the above three rankings, for example, it may be possible to perform ranking depending on whether a reference relationship pair related to specific referenced data is provided. Alternatively, the generation unit 13 may not perform ranking. For example, the generation unit 13 may include the overall intermediate reference relationship information in presentation information, randomly select one or more reference relationship pairs with the reference certainty information of “uncertainty”, and provide it as presentation information.

### (Instruction Unit 14)

The instruction unit 14 generates reference instruction information based on input information from the input unit 2. For example, if the “non-reference relationship” is selected for a given reference relationship pair, the instruction unit 14 generates reference instruction information showing that the reference relationship pair is the “non-reference relationship”, and stores it in the storage unit 17. FIG. 20 is a diagram illustrating reference instruction information generated based on input information in which the non-reference relationship is selected in FIG. 18.

### (Conversion Unit 15)

The conversion unit 15 converts intermediate reference relationship information into second reference relationship information using reference instruction information and reference dependence relationship information, and stores it in the storage unit 17.

FIG. 21 is a diagram illustrating an example of the second reference relationship information obtained by converting the intermediate reference relationship information in FIG. 12 using the reference instruction information in FIG. 20 and the reference dependence relationship information in FIG. 7. In the intermediate reference relationship information in FIG. 12, although the reference certainty information for the reference data “streams” and the referenced data “input_images” is uncertain, since the reference instruction information instructs that the reference relationship pair is regarded as a non-reference relationship, the reference relationship pair is deleted in the second reference relationship information in FIG. 21 (expressed by black filling in the figure). By regarding the reference relationship pair as a non-reference relationship, according to the reference dependence relationship information in FIG. 7, it is possible to regard that the reference data “s” and “stream” have a non-reference relationship with the referenced data “input_images”. Therefore, in the second reference relationship information in FIG. 21, regarding these reference relationship pairs, the reference relationship pairs are deleted.

Advantages of using the reference dependence relationship information is to: (A) give an instruction to a plurality of reference relationship pairs by an instruction to one reference relationship pair; and (B) separate the reference relationship pair to which the instruction is given, from the reference relationship pairs requested to obtain an effect of the instruction.

Above (A) means that it is possible to give an instruction to many reference relationships by less instruction, that is, it is possible to reduce the cost to analyze the first program 21 and the cost for the user to create the reference instruction information, by less instruction given by the user.

Above (B) means that the user can give an instruction to many reference relationships viscerally. For example, in the intermediate reference relationship information in FIG. 12, a reference relationship pair in which the reference relationship is requested to be clarified is the reference data “stream” or “images_1” and each referenced data of indirect data access with the uncertain reference relationship in the group access information in FIG. 14. When an instruction is given to the reference relationship pair of the reference data “stream” and the referenced data “input_images”, in a case where the reference dependence relationship information is not used, the following operations (1) to (5) are required of the user.
(1) The reference data “stream” is found as a parameter of the function “transfer_image”.
(2) Since the function “transfer_image” has the internal attribute, it is found that there is only one function call in the function “transfer_image_all”.
(3) It is found that the parameter “s” of the function “transfer_image” can be obtained from “streams” according to a “foreach” statement.
(4) The reference data “streams” is found as a parameter of the function “transfer_image_all”.
(5) Parameters of the all function calls of the function “transfer_image_all” are analyzed, data to be accessed by the reference data “stream” is found to give the reference instruction information.

By contrast with this, in the present embodiment, by using reference dependence relationship information, the generation unit 13 performs the above operations (1) to (4). Therefore, the user needs not perform the above operations (1) to (4). If the reference dependence relationship information is not used, it is necessary to give a non-visceral instruction to the reference data “stream”. According to the present embodiment, the user can give a visceral instruction to the reference data “streams” by a button.

Although only two simple functions are provided in the above explanation, even in a case where more functions are provided or a more complicated code is provided, it is possible to further reduce the user's workload by using the reference dependence relationship information of the present embodiment.

### (Optimization Unit 16)

The optimization unit 16 constructs the optimized second program 22 from the program information using the second reference relationship information and outputs it. To be more specific, the optimization unit 16 updates the group access information using the second reference relationship information and finds task group attribute information based on the updated group access information. Next, based on the task group attribute information, regarding referenced data used only in one task group, the optimization unit 16 identifies a definition position of the referenced data in the program information and constructs the second program 22 by inserting an optimization keyword “optimized task” in the definition position of the program information.

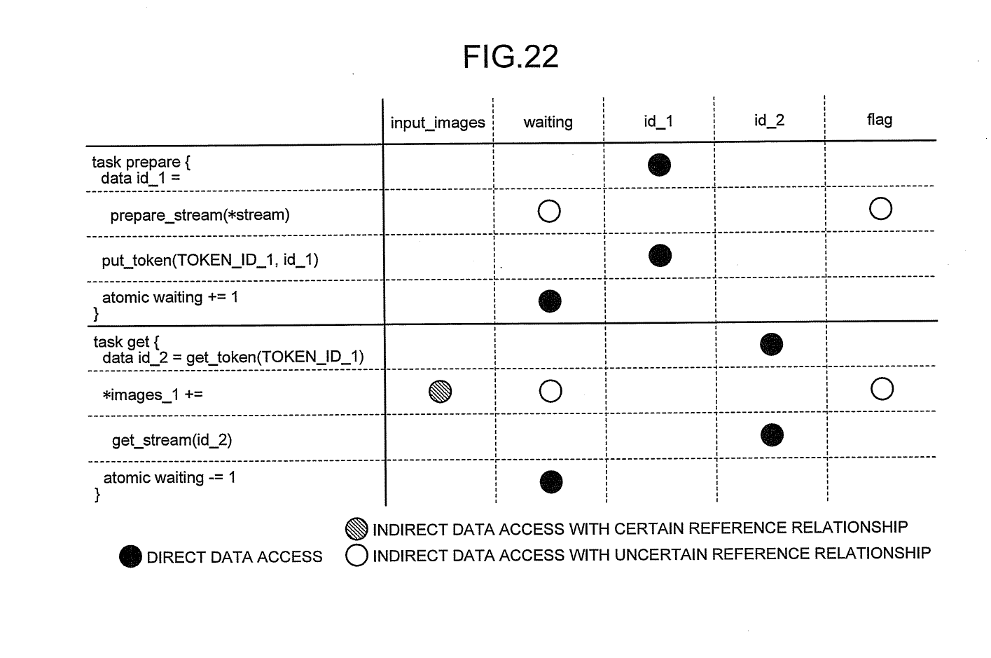

FIG. 22 is a diagram illustrating an example of updating the group access information in FIG. 10 using the second reference relationship information in FIG. 21. A difference from FIG. 14 is that the uncertain-reference-relationship data access 103 in FIG. 14 is removed. This is because the reference data “stream” and the referenced data “input_images” have a non-reference relationship and the indirect access “*stream” is regarded not to access the referenced data “input_images”.

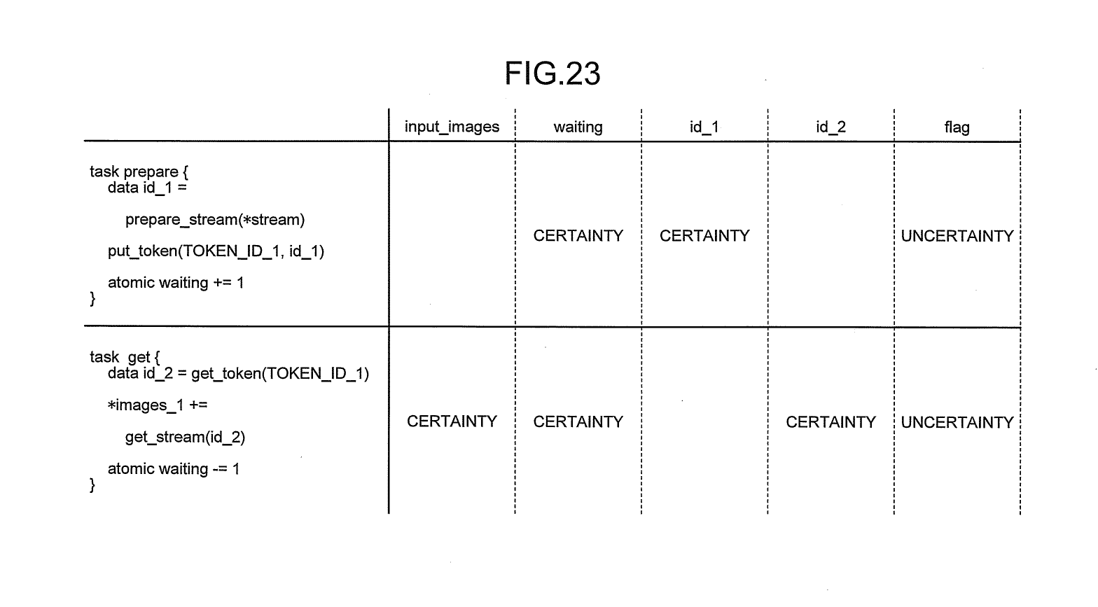

FIG. 23 is a diagram illustrating the task group attribute for each referenced data obtained from the group access information in FIG. 22. A difference from FIG. 15 is that, since the uncertain-reference-relationship data access 103 in FIG. 14 is deleted, it is regarded that the referenced data “input_images” is not accessed by a task group including the task “prepare” (which is expressed by a blank in FIG. 22).

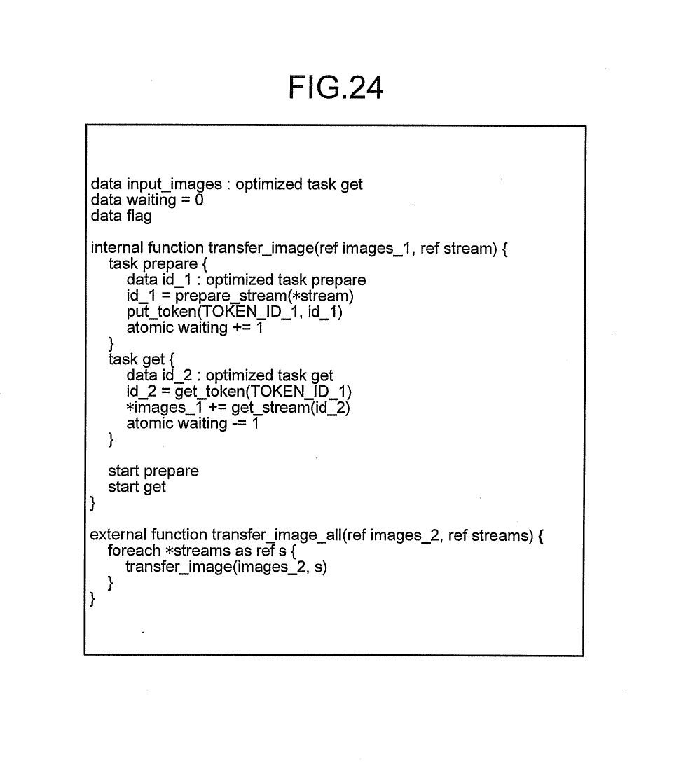

FIG. 24 is a diagram illustrating an example of the second program 22 in which the optimization instruction “optimized task” keyword is given to referenced data based on the program information in FIG. 11 using the task group attribute information in FIG. 23.

The “optimized task” keyword shows that designated referenced data is used only in the task group, the name of which follows the “optimized task” keyword. A compiler can perform optimization based on the “optimized task” keyword. For example, In FIG. 24, the “optimized task prepare” keyword is assigned to the definition sentence of “id_1”. Therefore, the compiler can optimize the task “prepare” with respect to the referenced data “id_1”. Similarly, it is possible to optimize the task “get” with respect to the referenced data “input_images” and “id_2”.

It is not necessary to give the reference instruction information to all reference relationship pairs with the reference certainty information of “uncertainty”, and, as shown in FIG. 21, the second reference relationship information may contain a reference relationship pair with the reference certainty information of “uncertainty”. The optimization unit 16 may process the reference relationship pair with the reference certainty information of “uncertainty” as a reference relationship pair with the reference certainty information of “certainty” as shown in the present embodiment, or may ignore and process the reference relationship pair as a non-reference relationship. However, in the case of ignoring the reference relationship pair in which a correct reference relationship is expressed, there is a case where it is not possible to generate the second program 22 that correctly operates. Therefore, in the case of ignoring and processing, as a non-reference relationship pair, a reference relationship pair with the reference certainty information of “uncertainty”, it is desirable to provide: (1) a method of not ignoring such a reference relationship pair so that it is possible to process its reference certainty information as “certainty”; and (2) a method of reporting that the second program 22 may not correctly operate in the case of the ignoring.

### (Program Variations)

The first program 21 and the second program 22 are not limited to the language exemplified in FIG. 4 and may be, for example, text files written in a programming language such as the C language and Java (registered trademark) or text files written in a unique programming language. The first program 21 and the second program 22 may be binary files such as an execution binary. Regarding the first program 21 and the second program 22, all information needs not be included in one file and may be divided into a plurality. The first program 21 and the second program 22 may not be in a file format and may be data on the storage unit 3. For example, a syntactic tree which is memory data generated in a C-language parsing apparatus may be input or output as the first program 21 and the second program 22.

The first program 21 and the second program 22 need not contain all essential processing and may be part of a large program. The first program 21 and the second program 22 may be expressed in different forms. For example, the first program 21 may be a text file described in the C language and the second program 22 may be an execution binary recorded on the storage unit 3.

### (Variations of Reference Data and Referenced Data)

A relationship between reference data and referenced data is relative and there may be data that is reference data and referenced data. For example, in the C language, normal data and pointer data have a relationship between referenced data and reference data, and, at the same time, pointer data and pointer data indicating the pointer address have a relationship between referenced data and reference data. In this case, the pointer data is reference data and referenced data.

### (Variations of Direct Data Access and Indirect Data Access)

There are various expression methods of direct data access and indirect data access depending on, for example, description, describing method or execution environment of programs. For example, in the C++ language, if “waiting” of the first program 21 in FIG. 4 is a user definition type and includes referenced data “A” and reference data “B” and if the referenced data “A” and referenced data “C” referred by the reference data “B” are accessed by an overloaded operator “+=”, “waiting+=1” includes direct data access to the referenced data “A” and indirect data access to the referenced data “C”.

In indirect data access, when referenced data is accessed using reference data, not only indirect data access to the referenced data but also direct data access to the reference data may be caused. For example, in the example of FIG. 4, by “*stream”, direct access to the reference data “stream” and indirect access to referenced data indicated by the reference data “stream” are performed.

### (Variations of Reference Relationship Information)

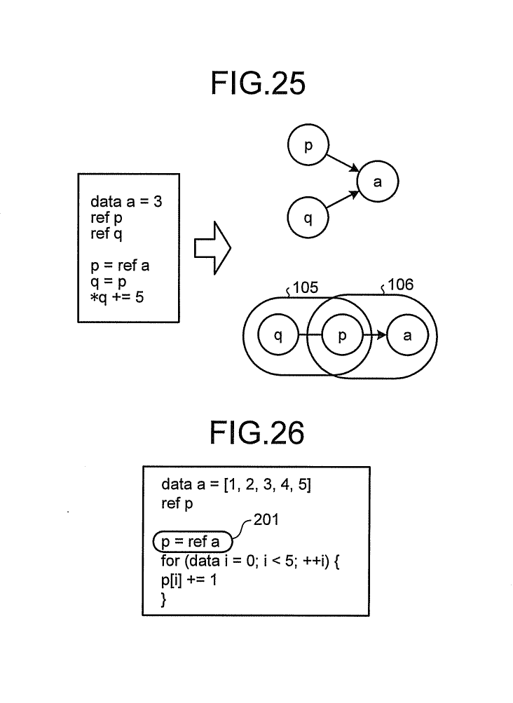

A configuration of a reference relationship pair needs not be a configuration directly connecting reference data and referenced data, and may express an indirect reference relationship between the reference data and the referenced data. FIG. 25 is a diagram illustrating an example of expressing an indirect reference relationship between reference data and referenced data. In the program shown on the left side of FIG. 25, after referenced data “a” is referred by reference data “p”, the reference data “p” is substituted to reference data “q”. As a method of expressing a reference relationship between the reference data “q” and the referenced data “a” obtained from this program, there are a method of directly expressing the reference relationship as shown in the upper right portion of FIG. 25 and a method of indirectly expressing the reference relationship as shown in the lower right portion of the figure.

In the lower right portion of FIG. 25, by a reference equivalence relationship pair 105 indicating that the reference data “p” and “q” are equivalent, and by a reference relationship pair 106 indicating the reference relationship between the reference data “p” and the referenced data “a”, and hence the reference relationship between the reference data “q” and the referenced data “a” is indirectly expressed. In the case of using the reference equivalence relationship pair, the analysis unit 11 extracts the reference equivalence relationship pair based on the first program 21 and stores it in the storage unit 17, so that it is possible to refer and use it at the time of the ranking by the generation unit 13 or generating the second program 22 by the optimization unit 16.

Any reference relationship information structure is possible as long as it includes information showing a combination of reference relationship pairs. For example, it is possible to express relationships between reference data and referenced data in a table structure or, for example, in an array with elements of data of structures by combinations of reference data and referenced data. For example, a graph structure is possible where, using reference data and referenced data as nodes, an edge between nodes indicates a reference relationship pair.

At the stage of generating the first reference relationship information, there may be a reference relationship pair with the reference certainty information of certainty. FIG. 26 is a diagram illustrating another example of the first program 21. For example, in the program in FIG. 26, using the “ref” keyword, “P=ref a” is set in row 201 and reference data of the referenced data “a” is substituted to the reference data “p”. In such a case, when generating the first reference relationship information, the analysis unit 11 may set the reference certainty information for the reference data “p” and the referenced data “a” to certainty.

### (Variations of Reference Dependence Relationship Information)

Any reference dependence relationship information is possible as long as it is possible to estimate dependence between reference relationship pairs. FIG. 7 directly expresses dependence between reference relationships, but it is not limited to this form. For example, if information that the reference data “images_1” and “images_2” are equivalent or a data flow of reference data is held as reference dependence relationship information, it is possible to estimate a reference dependence relationship related to reference relationship pairs indirectly having “images_1” and “images_2” as reference data.

### (Variations of Trace Information)

The trace information is not limited to the form shown in FIG. 8 and may be, for example, information recording reference data values. The reference data value is, for example, a memory address that is information enabling a position of referenced data to be identified. By recording reference data values, it is possible to identify referenced data that can be subjected to indirect data access, from the reference data values including a value of reference data that is not actually used for the indirect data access. By allowing the reflection unit 12 to input trace information of different characteristics, it is possible to use various kinds of trace information.

### (Variations of Access Count Information)

The access count information may not be a data access count obtained by executing the first program 21 but may be a data access estimation count obtained by analyzing the first program 21. For example, in the program in FIG. 26, (1) it is possible to analyze that the reference data “p” refers the array “a” of referenced data, (2) it is possible to analyze that a “for” loop is five rounds and (3) it is possible to analyze that access is performed totally two times (i.e. the reading and the writing) to add “1” to an element of the array “a” of the referenced data referred by the reference data “p” in the loop. Therefore, it is possible to estimate that the referenced data “a” is accessed 10 times if the program in FIG. 25 is executed.

If referenced data contains a plurality of items of referenced data, the access count information may hold the access count information of each contained referenced data. When first data contains second data, it shows that the first data is a data aggregate including the second data. For example, the C-language array is aggregate data of array elements and the array contains the array elements. For example, a C-language structure is aggregate data of structure members and the structure contains the structure members.

For example, the program shown in FIG. 26 may hold information of performing access two times (i.e. the reading and writing) to each element of the referenced data “a” at every round of the “for” loop. There are various units for the count in the access count information. As examples of the units, the number of “load” instructions and the number of “store” instructions issued by a CPU are processed as the access count, the size of data accessed by the “load” instructions and the “store” instructions is processed as the access count, or the occurrence count on the program is processed as the access count.

### (Variations of Analysis Unit)

In the present embodiment, the analysis unit 11 finds the first reference relationship information, the reference dependence relationship information, the group access information, the access count information and the trace information, but it may be possible to input one or more items of information from the external to the analysis unit 11. For example, using a dedicated apparatus, it may be possible to generate the group access information, the access count information and the trace information and input them in the analysis unit 11.

The program optimization apparatus 10 may be an apparatus removing part or all of the analysis unit 11, the reflection unit 12 and the optimization unit 16. For example, it is possible to configure a program analysis apparatus from which the optimization unit 16 is removed. In this case, the second reference relationship information output from the conversion unit 15 is an output (i.e. an analysis result of reference relationships between reference data and referenced data) of the program analysis apparatus.

As described above, in the present embodiment, the analysis unit 11 analyzes the first program 21 to generate the first reference relationship information for each reference data and referenced data, the reference dependence relationship information showing the dependence property between reference relationship pairs, information related to actual access of the first program 21 (i.e. trace information and access, count information), the group access information for each task group and the program information. By generating presentation information of data of a high optimization effect based on these, it is possible to realize the shortening of visual analysis time by the user. By reflecting the reference instruction information to a plurality of items of data by the user, it is possible to shorten the visual analysis time by the user and shorten the input time of the reference instruction information.

### Second Embodiment

Next, processing in the analysis unit 11 in the second embodiment will be explained. The configuration of the program optimization apparatus 10 of the present embodiment is the same as in the first embodiment. In the following, different parts from the first embodiment will be explained.

In the present embodiment, the analysis unit 11 extracts reference equivalence relationships showing equivalence relationships of reference data from the first program 21 and adds a reference equivalence relationship pair showing each reference equivalence relationship to the first reference relationship information. The reference equivalence pair indicates a relationship between the first reference data and the second reference data that can refer the same referenced data. Similar to the reference certainty information of reference relationships, it may be possible to use reference equivalence certainty information to show a reference equivalence relationship state.

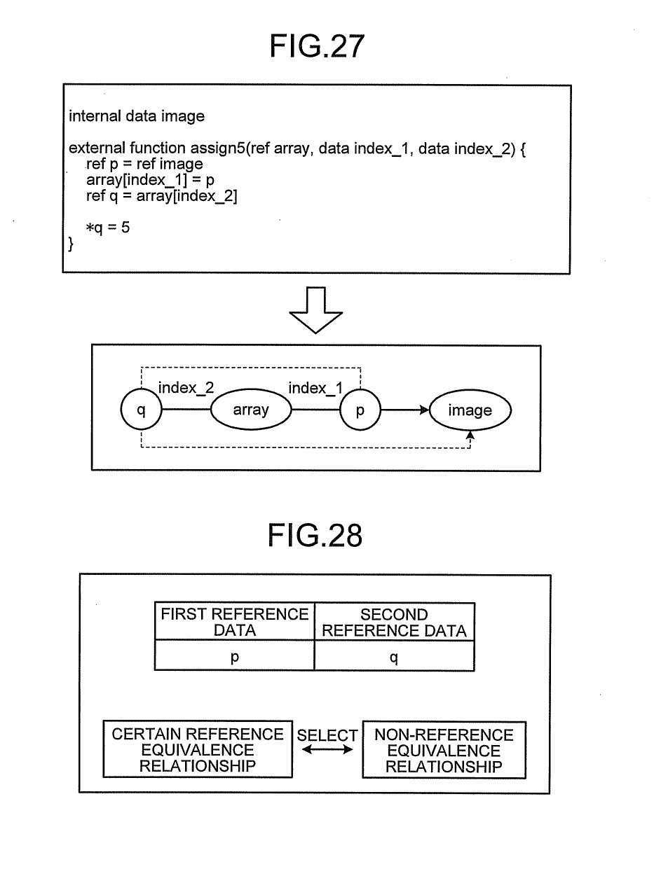

FIG. 27 is a diagram illustrating an example of the first reference relationship information according to the present embodiment. The upper portion of FIG. 27 shows an example of the first program 21 and the lower portion of FIG. 27 shows an example of the first reference relationship information. In the first reference relationship information in the lower portion of FIG. 27, nodes described with circles show reference data or referenced data, edges with arrows show reference relationship pairs and edges without arrows show reference equivalence relationship pairs. In the arrows showing the reference relationship pairs, the starting point indicates reference data and the ending point indicates referenced data. A solid-line edge shows that the reference certainty information or the reference equivalence certainty information indicates “certainty”, and a dashed-line edge shows that the reference certainty information or the reference equivalence certainty information indicates “uncertainty”. Regarding the first reference relationship information, as shown in the lower portion of FIG. 27, it may be possible to hold information of using each data as a node and defining the edge type connecting the nodes, or, similar to the first embodiment, it may be possible to perform management in a table form.

The “internal” keyword designated to the referenced data “image” means that, only from the inside of the program in FIG. 27, it is possible to obtain information as to whether the referenced data “image” is directly accessed or referred. The analysis unit 11 analyzes the first program 21 and sets the reference certainty information for the reference data “p” and the referenced data “image” to “certainty” since reference of the referenced data “image” is substituted to the reference data “p” by the “ref” keyword. Reference data “array” indicates reference to an array storing reference data as an element. Regarding the reference data “array”, there is a reference equivalence relationship between an element “index_1” of an array referred by the reference data “array” and the reference data “p” and there is a reference equivalence relationship between an element “index_2” of the array referred by the reference data “array” and the reference data “q”. The reference data “p” and “q” may have a reference equivalence relationship, depending on the relationship between the elements “index_1” and “index_2” of the array. In FIG. 27, reference equivalence relationships related to reference data “array[index_1]” and “array[index_2]” are collected in one node “array” and the elements “index_1” and “index_2” are provided as an edge, but it may be possible to output reference relationship information in which the reference data “array[index_1]” and “array[index_2]” are processed as different nodes.

A case where a reference equivalence relationship is certain shows that, in a reference equivalence relationship pair of first reference data and second reference data, it is regarded that the first reference data and the second reference data always refer or sometimes refer the same referenced data. Therefore, even in a reference equivalence relationship pair in which the reference equivalence certainty information indicates certainty, the first reference data and the second reference data may not refer the same referenced data. A case where a reference equivalence relationship is uncertain means that it is not possible to decide that the first reference data and the second reference data can or cannot refer the same referenced data. A case where there is no reference equivalence relationship shows that it is regarded that the first reference data and the second reference data do not refer the same referenced data.

When the reference certainty information of a reference equivalence relationship pair indicates “certainty”, it shows that the reference equivalence relationship is certain. When the reference certainty information indicates “uncertainty”, it shows that the reference equivalence relationship is uncertain. In FIG. 27, the analysis unit 11 can decide that the reference equivalence relationship between the reference data “p” and “index_1” that is part of the array referred by the reference data “array” is certain, and therefore the reference certainty information is set to “certainty”. The analysis unit 11 cannot analyze the relationship between the array elements “index_1” and “index_2” only from the program 21 in FIG. 27, and therefore the reference equivalence certainty information for the reference data “p” and “q” is set to “uncertainty”.

The analysis unit 11 may analyze a dependence relationship between a reference relationship pair and a reference equivalence relationship pair, and add it to reference dependence relationship information. For example, when it is presumed that there is no reference equivalence relationship between the reference data “p” and the reference data “q” in FIG. 27, since the “internal” keyword is designated to the referenced data “image”, it can be regarded that there is no reference relationship between the reference data “q” and the referenced data “image”. For example, if it is presumed that the reference equivalence certainty information for the reference data “array[index_1]” and the reference data “array[index_2]” in FIG. 27 indicates “certainty”, it can be regarded that the reference certainty information for the reference data “q” and the referenced data “image” indicates “certainty”.

Similarly, the analysis unit 11 may extract the dependence relationship between a first reference equivalence relationship pair and a second reference equivalence relationship pair, and include it in the reference dependence relationship information. For example, if it is presumed that the reference equivalence certainty information for the reference data “array[index_1]” and reference data “array[index_2]” in FIG. 27 indicates “certainty”, it can be regarded that the reference equivalence certainty information for the reference data “p” and the reference data “q” indicates “certainty”. Any reference dependence relationship information is possible as long as it is possible to estimate dependence between a reference relationship pair and a reference equivalence relationship pair, so that it is possible to use the reference equivalence relationship pair in the same form as in FIG. 7, as the reference dependence relationship information.

The reflection unit 12 may use the trace information and generate the intermediate reference relationship information in which the reference equivalence certainty information included in the first reference relationship information is changed from uncertainty to certainty. For example, when the trace information for the reference data “p” and “q” in FIG. 27 is input and contains the record that the reference data “p” and “q” indicate the same referenced data, the reflection unit 12 generates the intermediate reference relationship information in which the reference equivalence certainty information for the reference data “p” and “q” of the first reference relationship information is changed from “uncertainty” to “certainty”.

The generation unit 13 may generate presentation information related to a reference equivalence relationship pair. For example, the generation unit 13 may include information related to a reference equivalence relationship pair with the reference equivalence certainty information of “uncertainty” in presentation information. In the example of FIG. 27, since the reference certainty information for the reference data “p” and “q” indicates “uncertainty”, information related to the reference equivalence relationship pair is output as presentation information. FIG. 28 is a diagram illustrating presentation information related to a reference equivalence relationship pair and illustrates an example of a screen display to encourage the user to input a reference equivalence relationship. In a case where there are a plurality of reference equivalence relationship pairs of “uncertainty”, it may be possible to select and display one or more items of presentation information. As a selection method of the displayed reference equivalence relationship pairs, for example, it is possible to use the same method as the selection method of presentation information of reference relationship pairs described in the first embodiment.

The instruction unit 14 may accept an input of instruction related to a reference equivalence relationship pair via the input unit 2 and generate reference instruction information. For example, in a case where: (1) reference of the referenced data “image” is obtained only in the inside of function “assign5” and (2) “index_1” and “index_2” do not have the same value, the user can decide that the reference data “p” and “q” do not refer the same referenced data. Therefore, as reference instruction information, it is possible to input information that the reference data “p” and “q” have a non-reference equivalence relationship. Then, the reference data “q” does not refer the referenced data “image”, and therefore it is possible to decide that a value of “5” cannot be substituted to the referenced data “image” by the function “assign5”.

In the case of accepting an input of instruction related to a reference equivalence relationship pair, for example, a button may be displayed to accept the user in the same way as an input related to a reference relationship.

The conversion unit 15 may generate second reference relationship information from intermediate reference relationship information using reference instruction information and reference dependence relationship information for reference equivalence relationship pair. For example, if reference instruction information that the reference data “p” and “q” are not in a reference equivalence relationship is given, for the first reference relationship information in FIG. 27, it is possible to delete a reference equivalence relationship pair of the reference data “array[index_1]” and the reference data “array[index_2]”. By using reference dependence relationship information, the conversion unit 15 can delete a reference equivalence relationship pair of the reference data “q” and the referenced data “image”. Operations of the present embodiment other than the above description are similar to the first embodiment.

As described above, in the present embodiment, a reference equivalence relationship is equally included in presentation information in the same way as a reference relationship. Therefore, regarding a reference equivalence relationship, similar to a reference relationship, by reflecting the reference instruction information to a plurality of items of data by the user, it is possible to shorten the visual analysis time by the user and shorten the input time of the reference instruction information.

### Third Embodiment

Next, processing in the optimization unit 16 of the third embodiment will be explained. A configuration of the program optimization apparatus 10 of the present embodiment is the same as in the first embodiment. In the following, different parts from the first embodiment will be explained.

In the first embodiment, a compiler is provided outside the program optimization apparatus 10 and a keyword indicating an instruction to the compiler is assigned to the program 22 by the optimization unit 16, but, in the present embodiment, the optimization unit 16 has a function as a compiler and outputs compiled data to the second program 22. In the present embodiment, the optimization unit 16 may not assign a keyword and may implement an optimization compile based on the task group attribute information shown in FIG. 23.

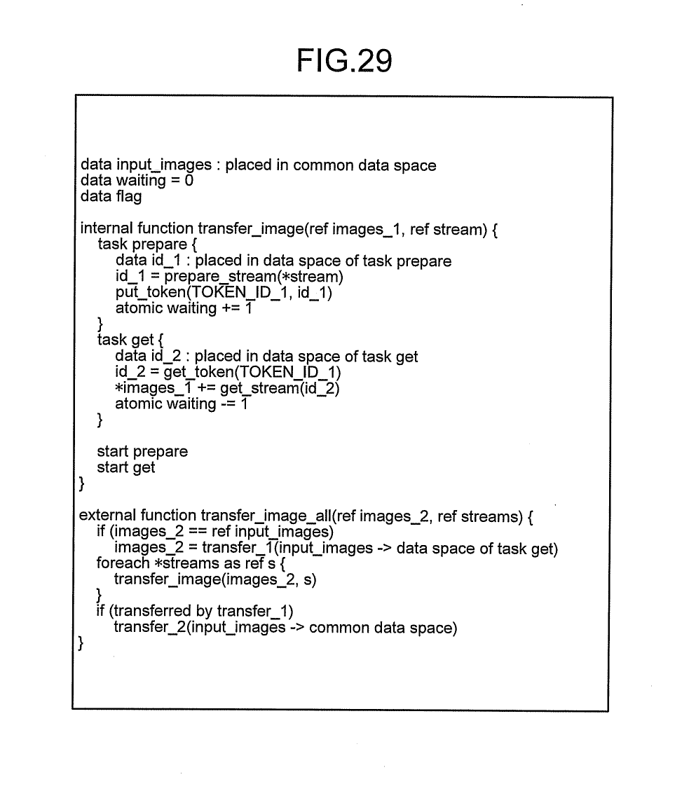

FIG. 29 is a diagram illustrating an example of expressing an executable file obtained by compiling and optimizing the second program 22 in FIG. 23 in a programming language form.

After the definition of referenced data, a data space to arrange the referenced data is shown. The data space denotes an area for data storage, for example, a memory of the storage unit 3, a data area such as a hard disk or part of this. In the same computer system, the storage unit 3 provides a logically-divided area and a physically-divided area such as the memory area given from the OS to each task and memory areas of different computers. In FIG. 29, the referenced data “input_images” is arranged in a common data space, the reference data “id_1” is arranged in a data space of the task “prepare”, and the referenced data “id_2” is arranged in a data space of the task “get”. Data arranged in the common data space can be accessed from all processing. Data arranged in a data space of a specific task can be accessed only from the corresponding task processing.

A case will be considered where the speed of access to the task data space is faster than the speed of access to the common data space. At this time, when the referenced data “input_images” is accessed by the task “get”, faster processing may be possible by temporarily moving the referenced data “input_images” to the data space of the task “get”. Therefore, the optimization unit 16 performs optimization processing as follows. The function “transfer_1” temporarily moves the referenced data “input_images” to the data space of the task “get” and substitutes a new reference to the reference data “images_2”. Then, the referenced data “input_images” moved by the task “get” in the function “transfer_image” is accessed and the function “transfer_2” returns the referenced data “input_images” to the common data space. Such optimization processing is executed only in a case where the reference data “images_2” refers the referenced data “input_images” in the “if” sentence. In a case where the reference data “images_2” refers referenced data different from “input_images”, the referenced data can be accessed even in the task “prepare” by the reference data “stream”. Therefore, if optimization is performed, since data can be inconsistent, the data is not moved for optimization.

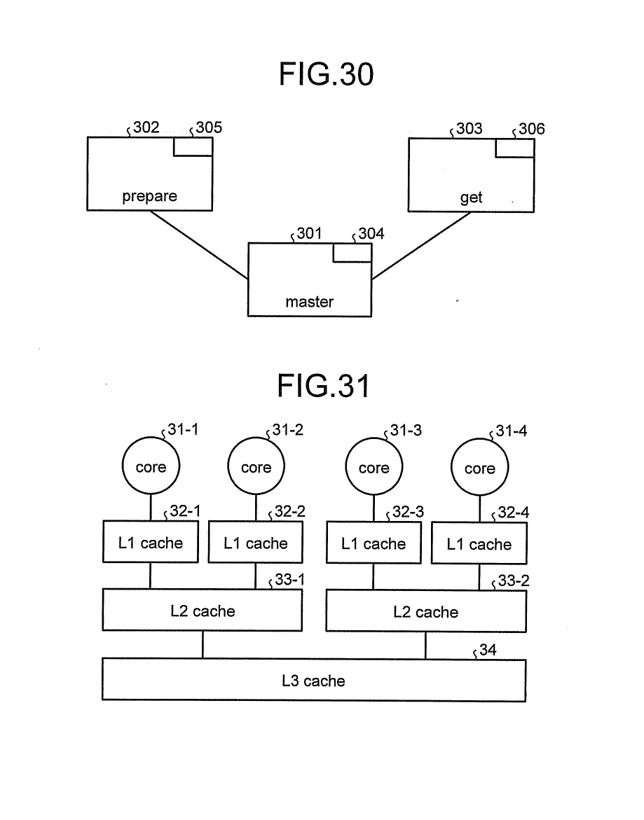

FIG. 30 is a diagram illustrating an example of a computer system where optimization (optimization for an executable file) effect according to the present embodiment is high. In the computer system in FIG. 30, three computers of “master” 301, “prepare” 302 and “get” 303 are connected via a network. “Master” 301 performs main processing, “prepare” 302 performs processing of the task “prepare”, and “get” 303 performs processing of the task “get”. Each computer holds a data space, that is, “master” 301 has a common data space 304, “prepare” 302 has a data space 305 and “get” 303 has a data space 306.

In a case where data in the common data space 304 is accessed by execution of the task “prepare” or the task “get”, the data is transferred to “master” 301 at that time. Accordingly, if the common data space is accessed many times by the task “prepare” or the task “get”, an immense amount of data transfer time may be required. Therefore, for example, by moving referenced data in the common data space 304 to the data space 306 in which faster access is possible from “get”, it may be possible to speed up processing.

In a case where the program optimization apparatus 10 is mounted on a computer system having a plurality of processor cores and caches, a task array to the processor cores may be optimized. FIG. 31 is a diagram illustrating a configuration example of a computer system having a plurality of processor cores. The computer system in FIG. 31 has cores (or processor cores) 31-1 to 31-4, L1 caches 32-1 to 32-4, L2 caches 33-1 and 33-2 and an L3 cache 34.

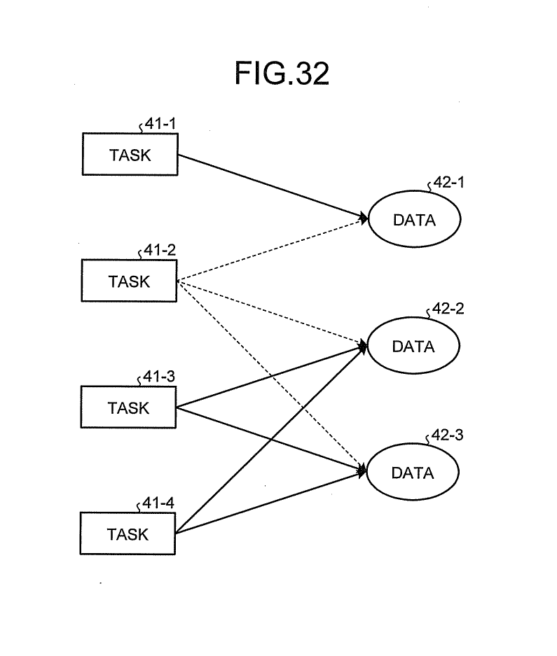

FIG. 32 illustrates an example of part of group access information extracted from the first program 21 in the analysis unit 11. In FIG. 32, regarding referenced data. 42-1 to 42-3 that can be accessed by tasks 41-1 to 41-4, access from the tasks 41-1 to 41-4 is expressed by arrows to the data 42-1 to 42-3. A solid-line arrow shows direct data access or indirect data access with the reference certainty information of “certainty” and a dashed-line arrow shows indirect data access with the reference certainty information of “uncertainty”.

A method of optimization processing of determining a processor core in the optimization unit 16 to execute each task shown in FIG. 32 will be explained. First, the analysis unit 11 analyzes the tasks 41-1 to 41-4 into task groups every referenced data that can be accessed. Here, a task to access a plurality of items of referenced data may belong to a plurality of task groups. The tasks 41-1 and 41-2 belong to a task group 43-1 that can access the data 42-1. The tasks 41-2 to 41-4 belong to a task group 43-2 that can access the data 42-2. The tasks 41-2 and 41-4 belong to a task group 43-3 that can access the data 42-3.

After that, similar to the first embodiment, the instruction unit 14 generates reference instruction information based on input information and the conversion unit 15 converts intermediate reference relationship information into second reference relationship information. By this means, if there is referenced data that is not regarded to be accessed from a given task, the optimization unit 16 reconfigures the task groups.

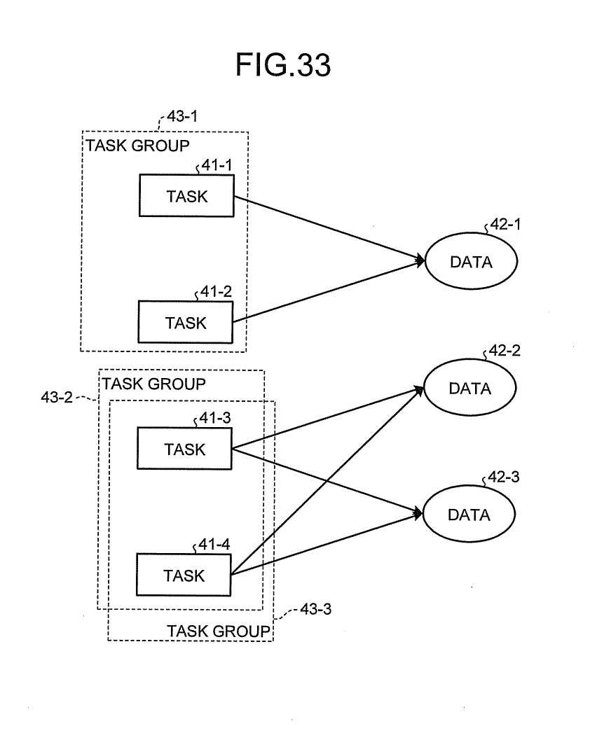

FIG. 33 is a diagram illustrating an example of reconfigured task groups. FIG. 33 illustrates an example where, as a result of conversion into second reference relationship information after the task groups are classified, it is regarded that the task 41-2 does not access the data 42-2 and 42-3. In this case, the optimization unit 16 removes the task 41-2 from the task groups 43-2 and 43-3 by reconfiguration. If the task groups are not reconfigured, there is an optimization problem as to whether (A) the task 41-2 is executed by the same processor core having the L2 cache as a processor core to execute the task 41-1 included in the task group 43-1 so that it is possible to efficiently access the data 42-1; or (B) the task 41-2 is executed by the same processor core having the L2 cache as a processor core to execute the tasks 41-3 and 41-4 included in the task groups 43-2 and 43-3 so that it is possible to efficiently access the data 42-2 and 42-3. However, by reconfiguring the task groups, the optimization unit 16 can select (A) and realize an efficient task execution. For example, by performing optimization to execute the tasks 41-1 and 41-2 in the cores 31-1 and 31-2 sharing the L2 cache 33-1, it is possible to access the data 42-1 not via the L3 cache 34 as much as possible.

The optimization unit 16 may perform optimization related to an automatic insertion of a synchronization code into tasks. For example, the tasks 41-2 and 41-3 in FIG. 32 can share data 42-2 and 42-3. Therefore, it is desired to insert a synchronization code into the tasks 41-2 and 41-3 to ensure that a correct calculation result is obtained, but, if it is judged that the tasks 41-2 and 41-3 do not share the same data as shown in FIG. 33, it is possible to perform optimization not to insert the synchronization code.

Operations of the present embodiment other than the above description are similar to the first embodiment. In a case where a reference equivalence relationship is considered as described in the second embodiment, it is possible to optimize the third embodiment.

The computer system mounting the program optimization apparatus 10 of the present embodiment is not limited to the configurations in FIGS. 30 and 31. An efficient optimization method depends on an actual computer system configuration. If the optimization unit 16 generates an executable file optimized to suit to the computer system, it is possible to further speed up processing.

As described above, in the present embodiment, the second program 22 is generated as an executable file and optimization is performed taking into account the computer system configuration. Therefore, it is possible to provide the same effect as in the first embodiment, perform optimization depending on the computer system and speed up processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program analysis apparatus that analyzes a reference relationship with referenced data that can be referred by reference data in an analysis target program, the apparatus comprising:
a generation unit configured to generate a reference relationship pair with reference certainty information of “uncertainty” as presentation information based on first reference relationship information including the reference certainty information showing whether it is “certain” or “uncertain” for the reference data to refer the referenced data, where the reference relationship pair comprises the reference data and the referenced data;
an instruction unit configured to generate a reference relationship of the reference relationship pair, as reference instruction information; and
a conversion unit configured to convert the first reference relationship information into second reference relationship information using the reference instruction information and reference dependence relationship information showing a dependence relationship between first and second reference relationship pairs,
wherein the conversion unit performs conversion into the second reference relationship information by estimating a reference relationship of the second reference relationship pair based on a reference relationship of the first reference relationship pair.

2. The program analysis apparatus according to claim 1, further comprising an analysis unit configured to generate at least one of the first reference relationship information and the reference dependence relationship information by performing analysis of the analysis target program.

3. The program analysis apparatus according to claim 1, wherein the generation unit performs ranking of the reference relationship pair with the reference certainty information of “uncertainty” and generates the presentation information based on the rank.

4. The program analysis apparatus according to claim 3, wherein the generation unit performs the ranking based on an access attribute of a function to which the reference relationship pair belongs.

5. The program analysis apparatus according to claim 3, wherein:
the analysis unit analyzes an access count every reference data or/and referenced data in the analysis target program; and
the generation unit performs the ranking based on the access count.

6. The program analysis apparatus according to claim 1, further comprising an analysis unit configured to form a task group with one or more tasks in the analysis target program and generate group access information indicating whether an access supporting a reference relationship pair belonging to the task group is a direct data access or an indirect data access.

7. The program analysis apparatus according to claim 6, wherein the generation unit performs ranking of the reference relationship pair with the reference certainty information of “uncertainty” based on the group access information and the second reference relationship pair; among reference relationship pairs for which reference data performs the indirect data access, process a certainty task group including the indirect data access by reference data to the reference relationship pair with the reference certainty information of “certainty”; process a uncertainty task group that is not the certainty task group and that includes an indirect data access by reference data to a reference relationship pair with reference certainty information of “uncertainty”; sets a higher rank to the reference relationship pair having referenced data, where a sum of a count of the certainty task group to which the referenced data belongs and a count of the uncertainty task group to which the referenced data belongs is equal to or more than two and the count of the certainty task group to which the referenced data belongs is equal to or less than 1.

8. The program analysis apparatus according to claim 1, further comprising:
an analysis unit configured to find trace information to be able to identify referenced data that is indirectly accessed using the reference data; and
a reflection unit configured to generate intermediate reference relationship information reflecting the trace information to the first reference relationship information,
wherein the conversion unit converts the intermediate reference relationship information into the second reference relationship information.

9. The program analysis apparatus according to claim 1, further comprising a reflection unit configured to generate intermediate reference relationship information reflecting trace information and the reference dependence relationship information to the first reference relationship information, the trace information to be able to identify referenced data that is indirectly accessed using the reference data,
wherein the conversion unit converts the intermediate reference relationship information into the second reference relationship information.

10. The program analysis apparatus according to claim 1, wherein:
the first reference relationship information further includes reference equivalence certainty information showing whether it is “certain” or “uncertain” for first and second reference data to refer same referenced data, for a reference equivalence relationship pair of the first reference data and the second reference data; and
the conversion unit estimates a reference relationship of a third reference relationship pair based on the reference dependence relationship information and performs conversion into the second reference relationship information.

11. The program analysis apparatus according to claim 10, the generation unit generates the presentation information further including a reference equivalence relationship pair with the reference equivalence certainty information of “uncertainty”.

12. The program analysis apparatus according to claim 1, further comprising an optimization unit configured to generate an optimization program obtained by optimizing the analysis target program based on the second reference relationship information.

13. The program analysis apparatus according to claim 12, wherein the optimization unit generates the optimization program in an executable file form.

14. The program analysis apparatus according to claim 12, wherein the optimization unit generates the optimization program based on the second reference relationship information to reduce data transfer between computers in a case where the computers to execute tasks of the analysis target program vary every task.

15. The program analysis apparatus according to claim 12, wherein:
the analysis target program is executed in a computer system comprising a plurality of processor cores and caches; and
the optimization unit generates the optimization program to execute a task in a processor core that can efficiently access the referenced data accessed by the task.

16. The program analysis apparatus according to claim 15, further comprising an analysis unit configured to form a task group with one or more tasks in the analysis target program and generate group access information indicating whether an access supporting a reference relationship pair belonging to the task group is a direct data access or an indirect data access, wherein:
the analysis unit forms'the task groups such that tasks referring same referenced data belong to a same task group; and
the optimization unit reconfigures the task groups, in a case where there arises the referenced data regarded not to be accessed from a task, to remove the task from the task group supporting referenced data based on the reference instruction information.

17. A program analysis method of analyzing a reference relationship between reference data and referenced data that can be referred by the reference data in an analysis target program, the method comprising:
generating a reference relationship pair with reference certainty information of “uncertainty” as presentation information based on first reference relationship information including the reference certainty information showing whether it is “certain” or “uncertain” for the reference data to refer the referenced data, where the reference relationship pair comprises the reference data and the referenced data;
generating a reference relationship of the reference relationship pair input based on the presentation information, as reference instruction information;
converting the first reference relationship information into second reference relationship information using the reference instruction information and reference dependence relationship information showing a dependence relationship between first and second reference relationship pairs; and
performing conversion into the second reference relationship information by estimating a reference relationship of the second reference relationship pair based on a reference relationship of the first reference relationship pair.

18. The program analysis method according to claim 17, further comprising analyzing the analysis target program and generating at least one of the first reference relationship information and the reference dependence relationship information.

19. The program analysis method according to claim 17, wherein the reference relationship pair with the reference certainty information of “uncertainty” is ranked to generate the presentation information based on the rank.

20. A storage medium recording an analysis program that causes a computer to execute a program analysis method according to claim 17.
